(19) United States
(12) Patent Application Publication
(10) Pub. No.: US 2022/0068197 A1
(43) Pub. Date: Mar. 3, 2022

(54) DISPLAY APPARATUS AND CONTROL METHOD THEREOF

(71) Applicant: SAMSUNG ELECTRONICS CO., LTD., Suwon-si (KR)

(72) Inventors: Daisuke KAWAE, Yokohama-shi (JP); Junichi Yamashita, Yokohama-shi (JP); Takashige Fujimori, Yokohama-shi (JP)

(73) Assignee: SAMSUNG ELECTRONICS CO., LTD., Suwon-si (KR)

(21) Appl. No.: 17/458,920

(22) Filed: Aug. 27, 2021

(30) Foreign Application Priority Data
Aug. 28, 2020 (JP) 2020-144459
May 10, 2021 (KR) 10-2021-0060091

(51) Int. Cl. G09G 3/32

(52) U.S. Cl. CPC G09G 3/32; G09G 2300/0876; G09G 2310/0267; G09G 2320/064

(57) ABSTRACT

A display apparatus is provided. The display apparatus includes a light-emitting device and a driving circuit configured to drive the light-emitting device, and including a constant current output circuit and a pulse width modulation (PWM) control circuit. The PWM control circuit includes: a first transistor including a first source connected to an output node of the constant current output circuit, a first drain connected to an anode of the light-emitting device, and a first gate connected to a control node; a second transistor including a second source connected to a first input terminal, a second gate connected to a second input terminal, and a second drain connected to the control node; and a third transistor including a third source connected to the control node, a third drain connected to a third input terminal, and a third gate to which an emitting permission signal or a bias voltage is applied.

### CROSS-REFERENCE TO RELATED APPLICATION(S)

This application is based on and claims priority under 35 U.S.C. § 119 to Japanese Patent Application No. 2020-144459, filed on Aug. 28, 2020, in the Japanese Patent Office, and Korean Patent Application No. 10-2021-0060091, filed on May 10, 2021, in the Korean Patent Office, the disclosures of which are incorporated by reference herein in their entireties.

### BACKGROUND

### 1. Field

The disclosure relates to a display apparatus and a control method thereof, and more particularly, to a display apparatus and a control method thereof for reducing the size of a pulse width modulation (PWM) driving circuit and reducing the manufacturing cost.

### 2. Description of the Related Art

Recently, a display apparatus in which self-emissive light-emitting devices, such as organic light emitting diodes (OLEDs) or micro light emitting diodes (LEDs), are mounted in the form of a 2-dimensional (2D) matrix is being developed. When micro LEDs are used as light-emitting devices, gradation representation of the light-emitting devices is, in many cases, performed by pulse width modulation (PWM) driving in view of color shift suppression of light-emitting. For example, Patent Document 1 discloses a configuration of a driving circuit for PWM driving light-emitting devices.

[Patent Document 1] Japanese Patent Publication No. 2014-150482.

However, the configuration of Patent Document 1 has a problem that manufacturing cost increases because a driving circuit for pulse width modulation (PWM) driving light-emitting devices has a configuration of a complementary metal-oxide semiconductor (CMOS) circuit.

To overcome the above described problem, one or more embodiments of the disclosure provide a display apparatus and a control method thereof for reducing the size of a PWM driving circuit and the manufacturing cost.

### SUMMARY

Additional aspects of the disclosure will be set forth in part in the description which follows and, in part, will be apparent from the description, or may be learned by practice of the disclosure.

According to an embodiment, there is provided a display apparatus including: a light-emitting device; and a driving circuit configured to drive the light-emitting device, the driving circuit including a constant current output circuit configured to output a constant current, and a pulse width modulation (PWM) control circuit. The PWM control circuit includes: a first transistor including a first source connected to an output node of the constant current output circuit, a first drain connected to an anode of the light-emitting device, and a first gate connected to a control node, the first transistor being turned on or off based on a voltage applied to the first gate; a second transistor including a second source connected to a first input terminal, a second gate connected to a second input terminal, and a second drain connected to the control node; and a third transistor including a third source connected to the control node, a third drain connected to a third input terminal, and a third gate to which an emitting permission signal or a bias voltage is applied.

The second transistor is turned on or off based on a first signal applied to the first input terminal and a second signal applied to the second input terminal, in a light-emitting mode, and the light-emitting device emits light based on the constant current flowing through the output node of the constant current output circuit, the second transistor being turned off, and the first transistor being turned on.

The third transistor is turned on based on a low level of the emitting permission signal applied to the third gate, and turned off based on a high level of the emitting permission signal, and the second transistor is turned off based on a voltage difference between the first signal and the second signal, and the voltage difference being lower than or equal to a preset threshold voltage, while the third transistor is in a turned-off state in the light-emitting mode, and the first transistor is turned on based on applying a low level voltage to the control node by turning-off of the second transistor.

The PWM control circuit further includes a fourth transistor positioned between the second gate of the second transistor and the second drain of the second transistor, wherein the fourth transistor is turned on based on a low level of a scan signal applied to a gate of the fourth transistor and turned off based on a high level of the scan signal.

An image signal is input to the first input terminal for a preset period in a scan mode, the third transistor is turned off for the preset period, and the fourth transistor is turned on for the preset period, and applies a voltage of the image signal applied to the first input terminal to the second gate of the second transistor and the control node.

The PWM control circuit further includes a fifth transistor positioned between the second gate of the second transistor and a reference voltage terminal, wherein the fifth transistor is turned on based on a low level of a reset signal applied to a gate of the fifth transistor and turned off based on a high level of the reset signal.

The fourth transistor is turned off in an initialization mode, and the fifth transistor is turned on in the initialization mode and applies a reference voltage to the second gate of the second transistor.

The PWM control circuit further includes: a capacitor device positioned between the third gate of the third transistor and the third source of the third transistor; and a first switch transistor positioned between the third gate of the third transistor and a bias voltage input terminal.

The first switch transistor is turned on based on a low level of a reset signal applied to a gate of the first switch transistor, turned off based on a high level of the reset signal, and turned on in an initialization mode to apply the bias voltage to the third gate of the third transistor.

The PWM control circuit further includes a second switch transistor positioned between the first gate of the first transistor and the second drain of the second transistor, and wherein the second switch transistor is turned on based on a low level of the emitting permission signal applied to a gate of the second switch transistor, and turned off based on a high level of the emitting permission signal applied to the gate of the second switch transistor.

The second switch transistor is turned on in the light-emitting mode, the second transistor is turned off based on a voltage difference between the first signal and the second signal, the voltage difference being lower than or equal to a preset threshold voltage, and the first transistor is turned on based on applying a low level voltage to the control node by turning-off of the second transistor.

The PWM control circuit further includes a capacitor device positioned between the second input terminal and the second transistor.

The constant current output circuit includes: a first metal-oxide semiconductor (MOS) transistor positioned between a fourth input terminal and the output node; a second MOS transistor positioned between a gate of the first MOS transistor and a drain of the first MOS transistor; a third MOS transistor positioned between the gate of the first MOS transistor and a reference voltage terminal; and a capacitor device positioned between the gate of the first MOS transistor and a supply voltage terminal.

The constant current output circuit includes: a first MOS transistor positioned between a fourth input terminal and the output node; a second MOS transistor positioned between a gate of the first MOS transistor and a drain of the first MOS transistor; a fourth MOS transistor connected in parallel to the light-emitting device; and a capacitor device positioned between the gate of the first MOS transistor and a supply voltage terminal.

### BRIEF DESCRIPTION OF THE DRAWINGS

The above and other aspects, features and advantages of certain embodiments of the disclosure will be more apparent from the following description, taken in conjunction with the accompanying drawings of which:

FIG. 1 shows a circuit diagram of a pixel provided in a display apparatus according to an embodiment;

FIG. 2 is a timing chart representing operations of the display apparatus according to an embodiment;

FIG. 3 shows a circuit diagram of a pixel provided in a display apparatus according to an embodiment;

FIG. 4 is a timing chart representing operations of the display apparatus according to an embodiment;

FIG. 5 shows a circuit diagram of a pixel provided in a display apparatus according to an embodiment; and

FIG. 6 is a timing chart representing operations of the display apparatus according to an embodiment.

### DETAILED DESCRIPTION

### First Embodiment

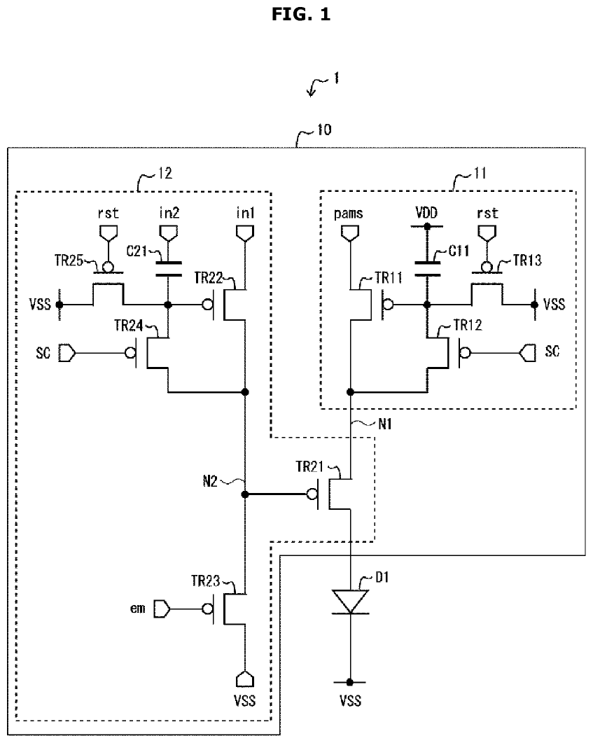

FIG. 1 shows a circuit diagram of a pixel 1 provided in a display apparatus according to a first embodiment of the disclosure. The display apparatus according to the first embodiment of the disclosure may be a self-emissive, active-matrix type display apparatus, such as, for example, an organic light-emitting diode (OLED) display, a micro light-emitting diode (LED) display, etc.

For example, the display apparatus according to the first embodiment of the disclosure may include a panel in which a plurality of pixels 1 are arranged in a form of a 2-dimensional (2D) matrix, and a control circuit including a data driver and/or a scan driver. The control circuit may scan the plurality of pixels 1 arranged in the form of, for example, the 2D matrix sequentially for each row, and input an image signal to the pixels 1 of the scanned row. For example, after image signals are input to all the pixels 1, the control circuit may cause light-emitting devices of the pixels 1 to emit light at the same time.

As shown in FIG. 1, each pixel 1 may be configured with a light-emitting device D1 and a pixel circuit (driving circuit) 10 for pulse width modulation (PWM) driving the light-emitting device D1.

The light-emitting device D1 may be a self-emissive device, and may be, for example, an organic electroluminescence (EL) or a micro LED. In the first embodiment of the disclosure, the light-emitting device D1 will be described as a micro LED. In many cases, gradation representation of the light-emitting device D1, which is a micro LED, may be performed by PWM driving in view of suppressing a color shift of light emission.

The pixel circuit 10 may include a constant current output circuit (constant current source) 11 and a PWM control circuit 12.

The constant current output circuit 11 may be configured to output constant current. More specifically, the constant current output circuit 11 may include transistors TR11, TR12, and TR13, and a first capacitor device (first capacitor) C11. The transistors TR11, TR12, and TR13 may be P-channel transistors. However, the one or more embodiments are not limited thereto, and the transistors TR11, TR12 and TR13 may be N-channel transistors. For distinction from transistors which will be described later, the transistors TR11, TR12, and TR13 may also be referred to as a first MOS transistor, a second MOS transistor, and a third MOS transistor, respectively.

The transistor TR11 may be positioned between an input terminal pams and a node N1, which is an output node of the constant current output circuit 11. A supply voltage VDD from outside may be supplied to the input terminal pams, an input voltage Vpam corresponding to an image signal may be supplied to the input terminal pams, or the input terminal pams may be set to a HiZ state, according to an operation mode. The HiZ state may be an abbreviation of ‘high impedance state’, and setting an input terminal (for example, the input terminal pams) to a HiZ state may mean the input terminal is at a state in which no signal is supplied to the input terminal, that is, the input terminal is in an off state. Also, an output being in a HiZ state may mean a state in which there is no output.

The transistor TR13 may be positioned between a gate of the transistor TR11 and a reference voltage terminal (hereinafter, referred to as a reference voltage terminal VSS) to which a reference voltage (herein, a ground voltage VSS) is supplied, and the transistor TR13 may be turned on or off based on a reset signal rst applied to a gate of the transistor TR13 through a reset signal input terminal (hereinafter, referred to as a reset signal input terminal rst). For example, the transistor TR13 may be turned on in response to a low (L) level of the reset signal rst, and turned off in response to a high (H) level of the reset signal rst.

The transistor TR12 may be positioned between the gate of the transistor TR11 and a drain of the transistor TR11, and may be turned on or off based on a scan signal SC applied to a gate of the transistor TR12 through a scan signal input terminal (hereinafter, referred to as a scan signal input terminal SC). For example, the transistor TR12 may be turned on in response to a low (L) level of the scan signal SC, and turned off in response to a high (H) level of the scan signal SC.

The capacitor device C11 may be positioned between the gate of the transistor TR11 and a supply voltage terminal (hereinafter, referred to as a supply voltage terminal (VDD)) to which a supply voltage VDD is supplied. The capacitor device C11 may be referred to as a first capacitor.

The PWM control circuit 12 may include transistors TR21, TR22, TR23, TR24, and TR25, and a capacitor device C21. In the current embodiment of the disclosure, a case in which all the transistors TR21, TR22, TR23, TR24, and TR25 are P-channel MOS transistors will be described as an example. To distinguish the terms from one another, the transistors TR21, TR22, TR23, TR24, and TR25 may be referred to as a first transistor TR21, a second transistor TR22, a third transistor TR23, a fourth transistor TR24, and a fifth transistor TR25, respectively, and the capacitor device C21 may be referred to as a second capacitor.

The transistor (control transistor) TR21 may be positioned between the node N1 which is an output node of the constant current output circuit 11, and an anode of the light-emitting device D1. A first source of the transistor TR21 may be connected to the output node N1, and a first drain of the transistor TR21 may be connected to the anode of the light-emitting device D1. The transistor TR21 may be turned on or off based on a voltage of a node (control node) N2. For example, the transistor TR21 may be turned on in response to the reference voltage VSS (low level voltage) applied to the node N2, and turned off in response to the supply voltage VDD (high level voltage) applied to the node N2. The control transistor TR21 may be referred to as the first transistor.

The transistor TR22 may be an ‘amplification transistor’, and positioned between an input terminal in1 (also referred to as a first input terminal) and the control node N2. A second source of the transistor TR22 may be connected to the first input terminal in1, a second drain of the transistor TR22 may be connected to the control node N2, and a second gate of the transistor TR22 may be connected to a second input terminal in2. A supply voltage VDD from outside may be supplied to the input terminal in1, an image signal (voltage Vpwm corresponding to an image signal) Vpwm may be supplied to the input terminal in1, or the input terminal in1 may be set to a HiZ state, according to an operation mode. The transistor TR22 may also be referred to as the second transistor.

The transistor TR 25 (or third switch transistor) may be positioned between the gate of the transistor TR22 and the reference voltage terminal VSS, and turned on or off based on a reset signal rst applied to a gate of the transistor TR25. For example, the transistor TR25 may be turned on in response to a low (L) level of the reset signal rst, and turned off in response to a high (H) level of the reset signal rst. The transistor TR25 may be referred to as the fifth transistor.

The transistor TR24 (or second switch transistor) may be positioned between the gate of the transistor TR22 and the drain of the transistor TR22, and turned on or off based on a scan signal SC applied to a gate of the transistor TR24. For example, the transistor TR24 may be turned on in response to a low (L) level of the scan signal SC, and turned off in response to a high (H) level of the scan signal SC. The transistor TR24 may be referred to as the fourth transistor.

The capacitor device C21 may be positioned between the gate of the transistor TR22 and the input terminal in2. A constant voltage representing a maximum value of an image signal from outside may be supplied to the input terminal in2, or a slope signal having a saw-tooth waveform may be supplied to the input terminal in2.

The transistor TR23 (or first switch transistor) may be positioned between the reference voltage terminal VSS and the node N2. A third source of the transistor TR23 may be connected to the control node N2, and a third drain of the transistor TR23 may be connected to the reference voltage terminal VSS. The transistor TR23 may be turned on or off based on an emitting permission signal em applied to a third gate of the transistor TR23 through an input terminal em. For example, the transistor TR23 may be turned on in response to a low (L) level (also, inactive) of the emitting permission signal em and turned off in response to a high (H) level (also, active) of the emitting permission signal em. The transistor TR23 may be referred to as the third transistor. The reference voltage terminal VSS connected to the drain of the third transistor TR23 may also be referred to as a third input terminal.

According to an embodiment, a capacitor device may be additionally provided between the gate and source of the transistor TR21.

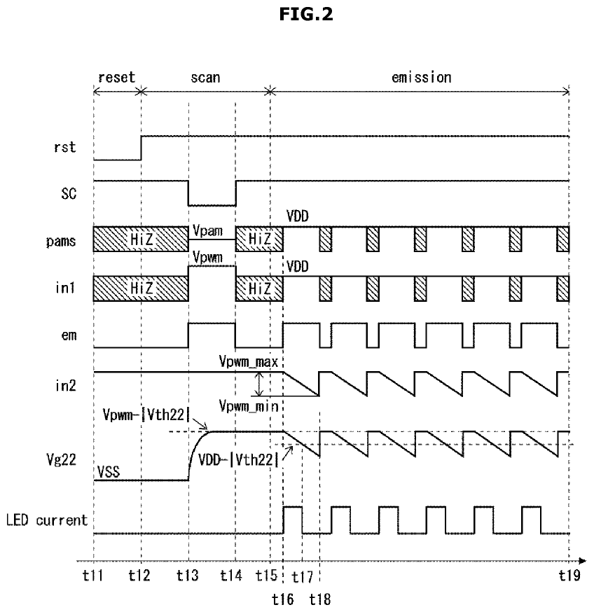

Hereinafter, operations (control method) of the display apparatus according to the first embodiment of the disclosure will be described with reference to FIG. 2 in conjunction with FIG. 1. FIG. 2 is a timing chart representing operations of the display apparatus according to the first embodiment of the disclosure. Operation modes of the display apparatus according to the first embodiment of the disclosure may be configured with an initialization mode, a scan mode, and a light-emitting mode. The initialization mode, the scan mode, and the light-emitting mode may also be referred to as an initialization period, a scan period, and a light-emitting period, respectively.

First, in the initialization mode (from time t11 to time t12), a reset signal rst may be set to a low (L) level, a scan signal SC may be set to a high (H) level, and an emitting permission signal em may be set to a low (L) level. Also, the input terminal pams in1 may be set to a Hiz state, and a voltage Vpwm_max which is a maximum voltage of an image signal Vpwm may be supplied to the input terminal in2. The input terminal pams may also be referred to as a fourth input terminal.

Accordingly, in the PWM control circuit 12, when the transistor TR25 is turned on in a turned-off state of the transistor TR24, a gate voltage Vg22 of the transistor TR22 may be initialized to the reference voltage VSS (0V).

Likewise, in the constant current output circuit 11, when the transistor TR13 is turned on in a turned-off state of the transistor TR12, a gate voltage Vg11 of the transistor TR11 may be initialized to the reference voltage VSS (0V).

Also, in the PWM control circuit 12, when the transistor TR23 is turned on, a voltage of the node N2 may be the reference voltage VSS (0V). Accordingly, the transistor TR21 may be turned on. However, because the input terminal pams is set to a HiZ state, and accordingly, an output of the constant current output circuit 11 is in the HiZ state, no current may flow through the light-emitting device D1. That is, the light-emitting device D1 may emit no light.

At time t12, the operation mode may be converted from the initialization mode to the scan mode.

In the scan mode (from time t12 to time t15), first, the reset signal rst may be converted from the low (L) level to a high (H) level (at time t12).

Accordingly, in the PWM control circuit 12, when the transistor TR25 is turned off, the gate of the transistor TR22 may enter a floating state in the state in which the reference voltage VSS is applied. Likewise, in the constant current output circuit 11, because the transistor TR13 is turned off, the gate of the transistor TR11 may enter a floating state in the state in which the reference voltage VSS is applied.

Thereafter, the scan signal SC may be temporarily converted from the high (H) level to a low (L) level, and the emitting permission signal em may be also temporarily converted from the low (L) level to a high (H) level accordingly (at time t13). Also, at this time, an image signal Vpwm may be supplied to the input terminal in1, and an input voltage Vpam corresponding to a constant current setting value may be supplied to the input terminal pams. Herein, a period (from time t13 to time t14) for which the image signal Vpwm is supplied to the input terminal in1 in the scan mode may also be referred to as an image signal supply mode.

Accordingly, in the PWM control circuit 12, when the transistor TR24 is turned on, the image signal Vpwm supplied to the input terminal in1 may be applied to the gate of the transistor TR22 through the transistors TR22 and TR24. At this time, a gate voltage Vg22 of the transistor TR22 may rise to Vpwm−|Vth22|, wherein Vpwm represents a voltage of the image signal Vpwm, and Vth22 represents a threshold voltage of the transistor TR22.

Likewise, in the constant current output circuit 11, when the transistor TR12 is turned on, the input voltage Vpam supplied to the input terminal pams may be applied to the gate of the transistor TR11 through the transistors TR11 and TR12. At this time, the gate voltage Vg11 of the transistor TR11 may become Vpam−|Vth11|, wherein Vth11 represents a threshold voltage of the transistor TR11.

Also, in the PWM control circuit 12, when the transistor TR23 is turned off, a voltage Vn2 of the node N2 may become Vpwm−|Vth22|. At this time, because the input voltage Vpam is supplied to the input terminal pams, an output voltage (voltage at the node N1) of the constant current output circuit 11 may become Vpam−|Vth11|. The input voltage Vpam may be set in advance such that a voltage difference Vgs21 (=Vn2−Vn1) between the gate and source of the transistor TR21 is lower than or equal to a threshold voltage Vth21 of the transistor TR21 (that is, |Vgs21|≤|Vth21|). Accordingly, when the transistor TR21 is turned off, no current may flow through the light-emitting device D1. That is, the light-emitting device D1 may emit no light.

Hereinafter, the scan signal SC may be again converted from the low (L) level to a high (H) level, and the emitting permission signal em may also be converted from the high (H) level to a low (L) level accordingly (at time t14). Also, the input terminal pams in1 may be again set to a HiZ state.

Accordingly, in the PWM control circuit 12, when the transistor TR24 is turned off, the gate of the transistor TR22 may enter a floating state in the state in which the voltage Vpwm−|Vth22| is applied (from time t14 to time t15). Likewise, in the constant current output circuit 11, when the transistor TR12 is turned off, the gate of the transistor TR11 may enter a floating state in the state in which the voltage Vpam−|Vth11| is applied (from time t14 to time t15).

Thereafter, the operation mode may be converted from the scan mode to the light-emitting mode (at time t15).

In the light-emitting mode (from time t15 to time t19), in the state in which the reset signal rst is fixed at the high (H) level and the scan signal SC is fixed at the high (H) level, a voltage of the emitting permission signal em may be converted periodically.

In a period for which the emitting permission signal em is in a low (L) level, the input terminals pams and in1 may be set to a HiZ state, and a fixed voltage Vpwm_max may be supplied to the input terminal in2. In contrast, in a period for which the emitting permission signal em is in a high (H) level, the supply voltage VDD may be supplied to the input terminals pams and in1 , and a slope signal (having a negative slope) falling from the voltage Vpwm_max to a voltage Vpwm_min may be supplied to the input terminal in2, wherein the voltage Vpwm_max represents a maximum voltage of the image signal Vpwm and the voltage Vpwm_min represents a minimum voltage of the image signal Vpwm.

First, in the period (for example, from time t15 to time t16) for which the emitting permission signal em is in the low (L) level, an output of the transistor TR22 may be in a HiZ state, and the transistor TR23 may be turned on. Therefore, a voltage of the node N2 may be the reference voltage VSS (0V). In other words, the voltage of the node N2 may be initialized to the reference voltage VSS. Accordingly, the transistor TR21 may be turned on. However, at this time, because the input terminal pams is set to a HiZ state, and accordingly, an output of the constant current output circuit 11 is in a HiZ state, no current may flow through the light-emitting device D1. That is, for a period in which the emitting permission signal em is in a low (L) level in the light-emitting mode, the light-emitting device D1 may emit no light.

Successively, in a period for which the emitting permission signal em is in a high (H) level, the transistor TR23 may be turned off, and the transistor TR22 may output a result of a comparison between an image signal Vpwm and a slope signal to the node N2.

Herein, a gate voltage Vg22 of the transistor TR22 may be expressed by Equation 1 below. Here, an amount of change from the voltage Vpwm_max of the input terminal in2 is ΔVin2.

Vg22=Vpwm−|Vth22|+ΔVin2 (1)

Also, on/off state of the transistor TR22 may be determined according to one of a voltage difference Vgs22 between the gate and source of the transistor TR22 and the threshold voltage Vth22 of the transistor TR22. For example, the transistor TR22 may be turned on when |Vgs22|−|Vth22|>0, and turned off when |Vgs22|−|Vth22|≤0.

Herein, |Vgs22|−|Vth22| may be expressed by Equation (2) below, rather than Equation (1).

$$\vert Vgs 22 \vert - \vert Vth 22 \vert = VDD - Vg 22 - \vert Vth 22 \vert = VDD - Vpwm + \vert Vth 22 \vert - Δ Vin 2 - \vert Vth 22 \vert = VDD - Vpwn - Δ Vin 2 \qquad ( 2 )$$

According to Equation (2), the transistor TR22 may perform on/off conversion without depending on the threshold voltage Vth22. That is, although the threshold voltage Vth22 changes or has characteristic deviation due to deterioration, the transistor TR22 may accurately output a result of a comparison between an image signal Vpwm and a slope signal.

For example, in response to a slope signal being a high voltage and a gate voltage Vg22 of the transistor TR22 being higher than or equal to VDD−|Vth22|, the transistor TR22 may be turned off (for example, from time t16 to time t17). At this time, because a voltage of the node N2 is maintained at the reference voltage VSS (initialized state), although the transistor TR23 is in a turned-off state, a voltage of a low level may be applied to the gate of the transistor TR21, and the transistor TR21 may be turned on. Accordingly, the light-emitting device D1 may emit light.

According to a gradual reduction of the voltage of the slope signal until the gate voltage Vg22 of the transistor TR22 becomes lower than VDD−|Vth22|, the transistor TR22 may be turned on (for example, from time t17 to time t18). Accordingly, the voltage of the node N2 may rise to the supply voltage VDD. Therefore, a voltage of a high level may be applied to the gate of the transistor TR21, and the transistor TR21 may be turned off. Accordingly, the light-emitting device D1 may stop emitting light.

In the light-emitting mode, the same operation as that performed for a period from time t15 to time t18 may be repeated (from time t15 to time t19). In the light-emitting mode, a rate (duty rate) of a light-emitting period of the light-emitting device D1, that is, brightness of the light-emitting device D1 may be determined based on an image signal Vpwm. As understood from the above description, a slope signal may have a slope (e.g., falling) of a waveform that looks as though the transistor TR22 is converted from off to on by a comparison with an image signal Vpwm by the transistor TR22.

As such, in the display apparatus according to the first embodiment of the disclosure, the transistors provided in the pixel circuit 10 may be MOS transistors of the same conductive type. Accordingly, the display apparatus according to the first embodiment of the disclosure may reduce cost compared with a case in which a CMOS circuit is used in a pixel circuit.

Also, because the pixel circuit 10 is controlled such that the transistors TR22 and TR23 are not simultaneously turned on, based on a current flowing through the transistors TR22 and TR23 may be suppressed to substantially zero. Herein, because the transistor TR23 is used as a switch transistor without being used as a load transistor, there may be no need for enlarging the size of a transistor to increase resistance, and accordingly, a circuit size may be reduced.

In the first embodiment of the disclosure, a case in which the transistors provided in the pixel circuit 10 are P channel MOS transistors has been described as an example. However, the disclosure is not limited to this. The transistors provided in the pixel circuit 10 may be N-channel MOS transistors.

### Second Embodiment

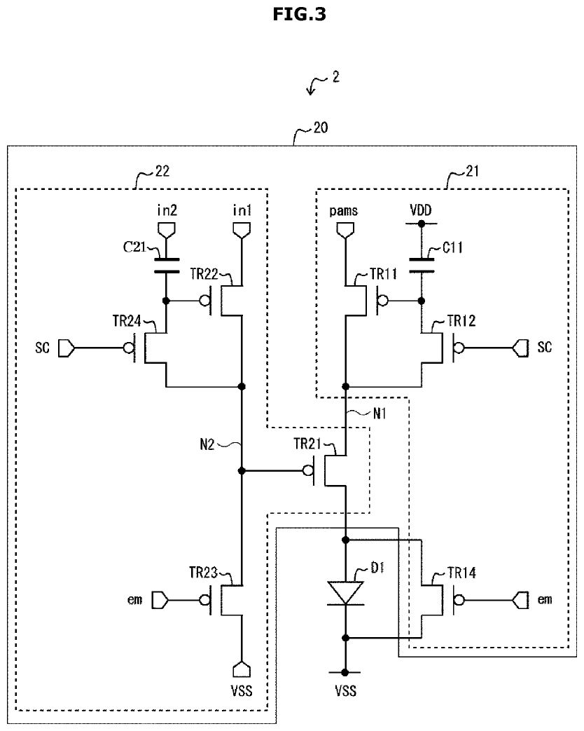

FIG. 3 shows a circuit diagram of a pixel provided in a display apparatus according to a second embodiment of the disclosure. The display apparatus according to the second embodiment of the disclosure may include a plurality of pixels 2 which is configured differently from the plurality of pixels 1 according to the first embodiment of the disclosure.

Referring to FIG. 3, a pixel 2 may include a light-emitting device D1 and a pixel circuit (driving circuit) 20 for PWM driving the light-emitting device D1.

The pixel circuit 20 may include a constant current output circuit (constant current source) 21, and a PWM control circuit 22. The constant current output circuit 21 and the PWM control circuit 22, provided in the pixel circuit 20, may respectively correspond to the constant current output circuit 11 and the PWM control circuit 12, provided in the pixel circuit 10.

The constant current output circuit 21 may include a transistor TR14, instead of the transistor TR13 in the constant current output circuit 11 according to the first embodiment. In the second embodiment of the disclosure, the transistor TR14 may be a P-channel MOS transistor. The transistor TR14 may also be referred to as a fourth transistor.

The transistor TR14 may be connected in parallel to a light-emitting device D1, and turned on or off based on a light-emitting permission signal em. For example, the transistor TR14 may be turned on in response to a low (L) level (also, inactive) of the emitting permission signal em, and turned off in response to a high (H) level (also, active) of the emitting permission signal em.

The other configurations of the constant current output circuit 21 may be the same as the corresponding ones of the constant current output circuit 11, and therefore, detailed descriptions thereof will be omitted.

The PWM control circuit 22 may not include the transistor TR25, compared with the PWM control circuit 12 in the first embodiment. The other configurations of the PWM control circuit 22 may be the same as the corresponding ones of the PWM control circuit 12, and therefore, detailed descriptions thereof will be omitted.

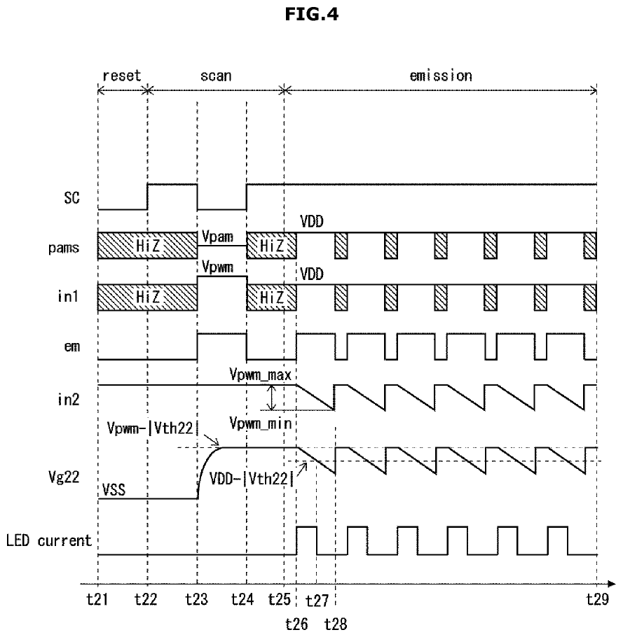

Hereinafter, operations (control method) of the display apparatus according to the second embodiment of the disclosure will be described with reference to FIG. 4 in conjunction with FIG. 3. FIG. 4 is a timing chart representing operations of the display apparatus according to the second embodiment of the disclosure. Hereinafter, operations that are different from those of the display apparatus according to the first embodiment of the disclosure will be mainly described. Also, operations performed for a period from time t21 to time t29 in the timing chart shown in FIG. 4 may correspond to operations performed for a period from time t11 to time t19 in the timing chart shown in FIG. 2.

First, in an initialization mode (from time t21 to time t22), a scan signal SC may be set to a low (L) level, and an emitting permission signal em may be set to a low (L) level. Also, the input terminals pams and in1 may be set to a HiZ state, and a voltage Vpwm_max which is a maximum voltage of an image signal Vpwm may be supplied to the input terminal in2.

Accordingly, in the PWM control circuit 22, when the transistors TR23 and TR24 are turned on, a gate voltage Vg22 of the transistor TR22 may be initialized to the reference voltage VSS (0V). That is, in the PWM control circuit 22, the gate voltage Vg22 may be initialized by using the transistors TR23 and TR24, instead of the transistor TR25.

Likewise, in the constant current output circuit 21, when the transistors TR14 and TR12 are turned on and the transistor TR21 is also turned on, a gate voltage Vg11 of the transistor TR11 may be initialized to the reference voltage VSS (0V). That is, in the constant current output circuit 21, the gate voltage Vg11 may be initialized by using the transistors TR12, TR14, and TR21, instead of the transistor TR13.

The other operations of the display apparatus according to the second embodiment of the disclosure may be the same as those of the display apparatus according to the first embodiment of the disclosure, and therefore, descriptions thereof will be omitted.

The display apparatus and the operations thereof according to the second embodiment of the disclosure may be equivalent to that of the display apparatus according to the first embodiment of the disclosure. That is, although the display apparatus according to the second embodiment is configured with different circuit structure compared to the first embodiment, the operations of the display apparatus may be the same.

Moreover, in the display apparatus according to the second embodiment of the disclosure, the transistors provided in the pixel circuit 20 may be MOS transistors of the same conductive type. Accordingly, the display apparatus according to the second embodiment of the disclosure may reduce cost compared with a case in which a CMOS circuit is used in a pixel circuit.

Also, when the pixel circuit 20 is controlled such that the transistors TR22 and TR23 are not simultaneously turned on, through current flowing through the transistors TR22 and TR23 may be suppressed to substantially zero. Herein, because the transistor TR23 is used as a switch transistor without being used as a load transistor, there may be no need for enlarging the size of a transistor to increase resistance, and accordingly, a circuit size may be reduced.

Also, the pixel circuit 20 may use a smaller number of transistors than that used in the pixel circuit 10, without using a reset signal rst. As such, the size of the pixel 2 may be further reduced according to the second embodiment.

In the second embodiment of the disclosure, a case in which the transistors provided in each pixel circuit 20 are P channel MOS transistors has been described as an example. However, the disclosure is not limited to this. The transistors provided in each pixel circuit 20 may be N channel MOS transistors.

### Third Embodiment

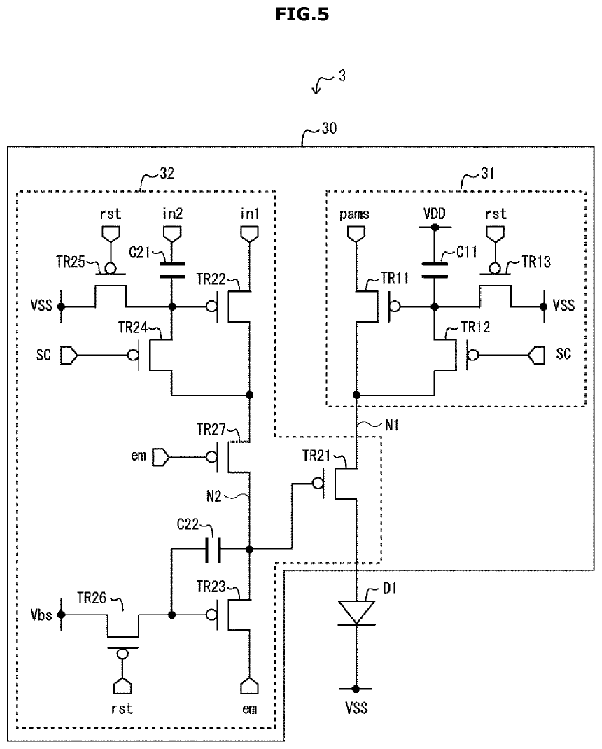

FIG. 5 shows a circuit diagram of a pixel provided in a display apparatus according to a third embodiment of the disclosure. The display apparatus according to the third embodiment of the disclosure may include a plurality of pixels 3, instead of the plurality of pixels 1, compared with the display apparatus according to the first embodiment of the disclosure.

Referring to FIG. 5, a pixel 3 may include a light-emitting device D1, and a pixel circuit (driving circuit) 30 for PWM driving the light-emitting device D1.

The pixel circuit 30 may include a constant current output circuit 31, and a PWM control circuit 32. The constant current output circuit 31 and the PWM control circuit 32, provided in the pixel circuit 30, may respectively correspond to the constant current output circuit 11 and the PWM control circuit 12, provided in the pixel circuit 10.

The constant current output circuit 31 may have the same circuit configuration as the constant current output circuit 11, and therefore, descriptions thereof will be omitted.

The PWM control circuit 32 may further include transistors TR26 and TR27, and a third capacitor device C22 (or third capacitor), compared with the PWM control circuit 12. Also, in the PWM control circuit 32, the transistor TR23 may be used as a load transistor, not as a switch transistor. In the third embodiment of the disclosure, a case in which all the transistors TR26 and TR27 are P channel MOS transistors will be described as an example.

The transistor TR23, which is a load transistor, may be positioned between the gate (node N2) of the transistor TR21 and an input terminal em. The input terminal em may also be referred to as a third input terminal.

The transistor TR26 (or first switch transistor) may be positioned between the gate of the transistor TR23 and a bias voltage input terminal (hereinafter, a bias voltage input terminal Vbs) to which a bias voltage Vbs is supplied, and the transistor TR26 may be turned on or off based on a reset signal rst applied to a gate of the transistor TR26. For example, the transistor TR26 may be turned on in response to a low (L) level of the reset signal rst, and turned off in response to a high (H) level of the reset signal rst.

The third capacitor device C22 (or third capacitor) may be positioned between the gate and source of the transistor TR23.

The transistor TR27 (or four switch transistor) may be positioned between the drains of the transistor TR22 and TR24 and the gate (node N2) of the transistor TR21, and turned on or off based on an emitting permission signal em applied to a gate of the transistor TR27. For example, the transistor TR27 may be turned on in response to a low (L) level (active) of the emitting permission signal em, and turned off in response to a high (H) level (inactive) of the emitting permission signal em.

The other configurations of the PWM control circuit 32 may be the same as the corresponding ones of the PWM control circuit 12, and therefore, detailed descriptions thereof will be omitted.

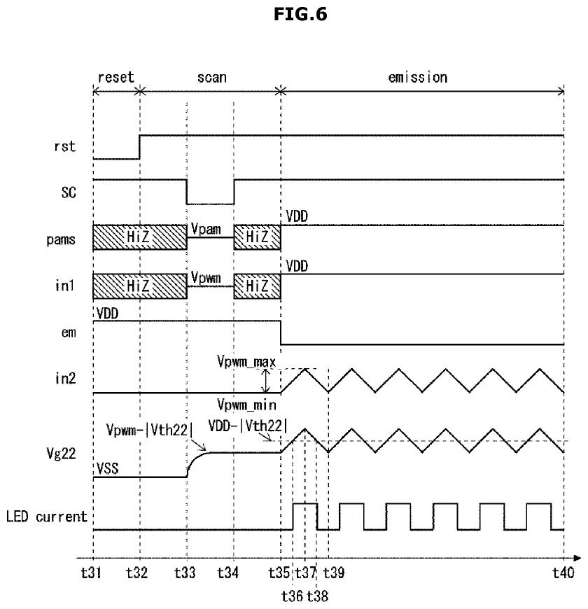

Hereinafter, operations (control method) of the display apparatus according to the third embodiment of the disclosure will be described with reference to FIG. 6 in conjunction with FIG. 5. FIG. 6 is a timing chart representing operations of the display apparatus according to the third embodiment of the disclosure. An operation mode of the display apparatus according to the third embodiment of the disclosure may be configured with, at least, an initialization mode, a scan mode, and a light-emitting mode.

First, in the initialization mode (from time t31 to time t32), a reset signal rst may be set to a low (L) level, a scan signal SC may be set to a high (H) level, and an emitting permission signal em may be set to a high (H) level. Also, the input terminals pams and in1 may be set to a HiZ state, and a voltage Vpwm_min, which is a minimum voltage of an image signal Vpwm, may be supplied to the input terminal in2.

Accordingly, in the PWM control circuit 32, when the transistor TR25 is turned on in a turned-off state of the transistor TR24, a gate voltage Vg22 of the transistor TR22 may be initialized to the reference voltage VSS (0V).

Likewise, in the constant current output circuit 31, when the transistor TR13 is turned on in a turned-off state of the transistor TR12, a gate voltage Vg11 of the transistor TR11 may be initialized to the reference voltage VSS (0V).

Also, in the PWM control circuit 32, when the transistor TR26 is turned on, a bias voltage Vbs may be applied to the gate of the transistor TR23. The bias voltage Vbs may be set to a high value such that the transistor TR23 used as a load transistor has high resistance.

Also, at this time, when the transistor TR27 is in a turned-off state, an emitting permission signal em of a high (H) level may be supplied to the node N2 through the transistor TR23 of high resistance. Accordingly, because the transistor TR21 is turned off, no current may flow through the light-emitting device D1. That is, the light-emitting device D1 may emit no light.

Thereafter, the operation mode may be converted from the initialization mode to the scan mode (at time t32).

In the scan mode (from time t32 to time t35), first, the reset signal rst may be converted from the low (L) level to a high (H) level (at time t32).

Accordingly, in the PWM control circuit 32, when the transistor TR25 is turned off, the gate of the transistor TR22 may enter a floating state in the state in which the reference voltage VSS is applied. Likewise, in the constant current output circuit 31, when the transistor TR13 is turned off, the gate of the transistor TR11 may enter a floating state in the state in which the reference voltage VSS is applied.

Also, in the PWM control circuit 32, when the transistor TR26 is turned off, the gate of the transistor TR23 may enter a floating state in the state in which the bias voltage Vbs is applied. Accordingly, the transistor TR23 may be implemented as a load transistor of high resistance without increasing a size of the transistor.

Thereafter, the scan signal SC may be temporarily converted from the high (H) level to a low (L) level (at time t33). Also, at this time, an image signal Vpwm may be applied to the input terminal in1 , and an input voltage Vpam corresponding to a constant current setting value may be supplied to the input terminal pams. Herein, a period (from time t33 to time t34) for which the image signal Vpwm is supplied to the input terminal in1 in the scan mode may be referred to as an image signal supply mode.

Accordingly, in the PWM control circuit 32, because the transistor TR24 is turned on, the image signal Vpwm supplied to the input terminal in1 may be applied to the gate of the transistor TR22 through the transistors TR22 and TR24. At this time, the gate voltage Vg22 of the transistor TR22 may rise to Vpwm−|Vth22I, wherein Vpwm represents a voltage of the image signal Vpwm, and Vth22 represents a threshold voltage of the transistor TR22.

Likewise, in the constant current output circuit 31, when the transistor TR12 is turned on, the input voltage Vpam supplied to the input terminal pams may be applied to the gate of the transistor TR11 through the transistors TR11 and TR12. At this time, the gate voltage Vg11 of the transistor TR11 may become Vpam−|Vth11|, wherein Vth11 represents a threshold voltage of the transistor TR11.

Also, at this time, when the transistor TR27 is in a turned-off state, the emitting permission signal em of the high (H) level may continue to be supplied to the node N2 through the transistor TR23 of high resistance. Accordingly, because the transistor TR21 is in a turned-off state, no current may flow through the light-emitting device D1. That is, the light-emitting device D1 may emit no light.

Thereafter, the scan signal SC may be again converted from the low (L) level to a high (H) level (at time t34). Also, the input terminals pams and in1 may be again set to a HiZ state.

Accordingly, in the PWM control circuit 32, when the transistor TR24 is turned off, the gate of the transistor TR22 may enter a floating state in the state in which the voltage Vpwm−|Vth22| is applied (from time t34 to time t35). Likewise, in the constant current output circuit 31, when the transistor TR12 is turned off, the gate of the transistor TR11 may enter a floating state in the state which the voltage Vpam−|Vth11| is applied (from time t34 to time t35).

Thereafter, the operation mode may be converted from the scan mode to the light-emitting mode (at time t35).

In the light-emitting mode (from time t35 to time t40), in the state in which the reset signal rst is fixed at a high (H) level and the scan signal SC is fixed at a high (H) level, the emitting permission signal em may become a low (L) level. Also, the supply voltage VDD may be supplied to the input terminals pams and in1, and a triangular wave periodic signal having a preset amplitude may be applied to the input terminal in2. That is, a slope signal having a triangular wave shape and having an amplitude between a voltage Vpwm_min and a voltage Vpwm_max, may be supplied to the input terminal in2. Here, the voltage Vpwm_max represents a maximum voltage of the image signal Vpwm and the voltage Vpwm_min represents a minimum voltage of the image signal Vpwm.

Accordingly, when the transistor TR27 is turned on, the transistor TR22 may output a result of a comparison between the image signal Vpwm and the slope signal to the node N2. A voltage difference Vgs23 between the gate and source of the transistor TR23 may be maintained at a constant value by a bootstrap operation of the third capacitor device C22, although the voltage of the node N2 changes. That is, the transistor TR23 may be maintained at high resistance. Accordingly, the transistor TR21 may be turned on or off according to the result of the comparison between the image signal Vpwm and the slope signal.

The gate voltage Vg22 of the transistor TR22 may be expressed by Equation 3 below, wherein an amount of change from the voltage Vpwm_min of the input terminal in2 is ΔVin2.

Vg22=Vpwm−|Vth22|+ΔVin2 (3)

Also, on/off of the transistor TR22 may be determined according to which one of a voltage difference Vgs22 between the gate and source of the transistor TR22 and the threshold voltage Vth22 of the transistor TR22 is greater. For example, the transistor TR22 may be turned on in the case of |Vgs22|−|Vth22|>0, and turned off in the case of |Vgs22|−|Vth22|≤0.

Herein, |Vgs22I|−|Vth22| may be expressed by Equation (4) below, rather than Equation (3).

$$\vert Vgs 22 \vert - \vert Vth 22 \vert = VDD - Vg 22 - \vert Vth 22 \vert = VDD - Vpwm + \vert Vth 22 \vert - Δ Vin 2 - \vert Vth 22 \vert = VDD - Vpwn - Δ Vin 2 \qquad ( 4 )$$

According to Equation (4), the transistor TR22 may perform on/off conversion without depending on the threshold voltage Vth22. That is, although the threshold voltage Vth22 changes or has characteristic deviation due to deterioration, the transistor TR22 may accurately output a result of a comparison between an image signal Vpwm and a slope signal.

For example, in response to the gate voltage Vg22 of the transistor TR22, which is lower than VDD−|Vth22|, in a rising period of the slope signal, the transistor TR22 may be turned on (for example, from time t35 to time t36). Accordingly, because the voltage of the node N2 becomes a high (H) level (supply voltage VDD), the transistor TR21 may be turned off. Accordingly, the light-emitting device D1 may emit no light. Thereafter, the slope signal may continue to rise until the gate voltage Vg22 of the transistor TR22 is higher than or equal to VDD−|Vth22|. In this case, the transistor TR22 may be turned off until the rising of the slope signal is completed (for example, from time t36 to time t37). Accordingly, because the voltage of the node N2 becomes a low (L) level (reference voltage VSS), the transistor TR21 may be turned on. Accordingly, the light-emitting device D1 may emit light.

Thereafter, in response to a gate voltage Vg22 of the transistor TR22, which is higher than or equal to VDD−|Vth22|, in a falling period of the slope signal, the transistor TR22 may be turned off (for example, from time t37 to time t38). Accordingly, because the voltage of the node N2 is maintained at a low (L) level, the transistor TR21 may be maintained in a turned-on state. Accordingly, the light-emitting device D1 may emit light. Thereafter, the slope signal may continue to fall until the gate voltage Vg22 of the transistor TR22 is lower than VDD−|Vth22|. In this case, the transistor TR22 may be turned on until the falling of the slope signal is completed (for example, from time t38 to time t39). Accordingly, because the voltage of the node N2 becomes a high (H) level, the transistor TR21 may be turned off. Accordingly, the light-emitting device D1 may stop emitting light.

In the light-emitting mode, the same operation as that performed for a period from time t35 to time t39 may be repeated (from time t35 to time t40). In the light-emitting mode, a rate (duty rate) of a light-emitting period of the light-emitting device D1, that is, brightness of the light-emitting device D1 may be determined based on an image signal Vpwm.

As such, in the display apparatus according to the third embodiment of the disclosure, the transistors provided in the pixel circuit 30 may be MOS transistors of the same conductive type. Accordingly, the display apparatus according to the third embodiment of the disclosure may reduce cost compared with a case in which a CMOS circuit is used in a pixel circuit.

Also, in the pixel circuit 30, a voltage difference Vgs23 between the gate and source of the transistor TR23 used as a load transistor may be maintained as a constant value by a bootstrap operation of the third capacitor device C22. Accordingly, the transistor TR23 may be maintained at high resistance without increasing the size of the transistor TR23. That is, the pixel circuit 30 may suppress through current flowing through the transistors TR22 and TR23 without increasing a circuit size. Also, the pixel circuit 30 may achieve constant through current over an entire output area, while ensuring an output amplitude (amplitude of the voltage of the node N2).

In the third embodiment of the disclosure, a case in which each transistor provided in the pixel circuit 30 is a P-channel MOS transistor has been described as an example. However, the embodiment is not limited to thereto. Each transistor provided in the pixel circuit 30 may be a N-channel MOS transistor.

Also, in the third embodiment of the disclosure, a case in which the drain of the transistor TR23 is connected to the input terminal em has been described as an example. However, the embodiment is not limited thereto. The drain of the transistor TR23 may be connected to the reference voltage terminal VSS. However, in this case, on/off of the transistor TR21 may need to be controlled by an emitting permission signal em from another path, as necessary.

According to the one or more embodiments of the disclosure, a display apparatus capable of reducing cost and size, and a control method thereof may be provided.

Although some embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. A display apparatus comprising:
a light-emitting device; and
a driving circuit configured to drive the light-emitting device, the driving circuit comprising a constant current output circuit configured to output a constant current, and a pulse width modulation (PWM) control circuit,
wherein the PWM control circuit comprises:
a first transistor including a first source connected to an output node of the constant current output circuit, a first drain connected to an anode of the light-emitting device, and a first gate connected to a control node, the first transistor being turned on or off based on a voltage applied to the first gate;
a second transistor including a second source connected to a first input terminal, a second gate connected to a second input terminal, and a second drain connected to the control node; and
a third transistor including a third source connected to the control node, a third drain connected to a third input terminal, and a third gate to which an emitting permission signal or a bias voltage is applied.

2. The display apparatus according to claim 1, wherein the second transistor is turned on or off based on a first signal applied to the first input terminal and a second signal applied to the second input terminal, in a light-emitting mode, and
the light-emitting device emits light based on the constant current flowing through the output node of the constant current output circuit, the second transistor being turned off, and the first transistor being turned on.

3. The display apparatus according to claim 2, wherein
the third transistor is turned on based on a low level of the emitting permission signal applied to the third gate, and turned off based on a high level of the emitting permission signal, and
the second transistor is turned off based on a voltage difference between the first signal and the second signal, and the voltage difference being lower than or equal to a preset threshold voltage, while the third transistor is in a turned-off state in the light-emitting mode, and
the first transistor is turned on based on applying a low level voltage to the control node by turning-off of the second transistor.

4. The display apparatus according to claim 1, wherein the PWM control circuit further comprises a fourth transistor positioned between the second gate of the second transistor and the second drain of the second transistor, wherein the fourth transistor is turned on based on a low level of a scan signal applied to a gate of the fourth transistor and turned off based on a high level of the scan signal.

5. The display apparatus according to claim 4, wherein
an image signal is input to the first input terminal for a preset period in a scan mode,
the third transistor is turned off for the preset period, and
the fourth transistor is turned on for the preset period, and applies a voltage of the image signal applied to the first input terminal to the second gate of the second transistor and the control node.

6. The display apparatus according to claim 4, wherein the PWM control circuit further comprises a fifth transistor positioned between the second gate of the second transistor and a reference voltage terminal, wherein the fifth transistor is turned on based on a low level of a reset signal applied to a gate of the fifth transistor and turned off based on a high level of the reset signal.

7. The display apparatus according to claim 6, wherein
the fourth transistor is turned off in an initialization mode, and
the fifth transistor is turned on in the initialization mode and applies a reference voltage to the second gate of the second transistor.

8. The display apparatus according to claim 2, wherein the PWM control circuit further comprises:
a capacitor device positioned between the third gate of the third transistor and the third source of the third transistor; and
a first switch transistor positioned between the third gate of the third transistor and a bias voltage input terminal.

9. The display apparatus according to claim 8, wherein the first switch transistor is turned on based on a low level of a reset signal applied to a gate of the first switch transistor, turned off based on a high level of the reset signal, and turned on in an initialization mode to apply the bias voltage to the third gate of the third transistor.

10. The display apparatus according to claim 8, wherein the PWM control circuit further comprises a second switch transistor positioned between the first gate of the first transistor and the second drain of the second transistor, and
wherein the second switch transistor is turned on based on a low level of the emitting permission signal applied to a gate of the second switch transistor, and turned off based on a high level of the emitting permission signal applied to the gate of the second switch transistor.

11. The display apparatus according to claim 10, wherein
the second switch transistor is turned on in the light-emitting mode,
the second transistor is turned off based on a voltage difference between the first signal and the second signal, the voltage difference being lower than or equal to a preset threshold voltage, and
the first transistor is turned on based on applying a low level voltage to the control node by turning-off of the second transistor.

12. The display apparatus according to claim 1, wherein the PWM control circuit further comprises a capacitor device positioned between the second input terminal and the second transistor.

13. The display apparatus according to claim 1, wherein the constant current output circuit comprises:
a first metal-oxide semiconductor (MOS) transistor positioned between a fourth input terminal and the output node;
a second MOS transistor positioned between a gate of the first MOS transistor and a drain of the first MOS transistor;
a third MOS transistor positioned between the gate of the first MOS transistor and a reference voltage terminal; and
a capacitor device positioned between the gate of the first MOS transistor and a supply voltage terminal.

14. The display apparatus according to claim 1, wherein the constant current output circuit comprises:
a first MOS transistor positioned between a fourth input terminal and the output node;
a second MOS transistor positioned between a gate of the first MOS transistor and a drain of the first MOS transistor;
a fourth MOS transistor connected in parallel to the light-emitting device; and
a capacitor device positioned between the gate of the first MOS transistor and a supply voltage terminal.
